(19) United States
(12) Patent Application Publication
(10) Pub. No.: US 2009/0303228 A1
(43) Pub. Date: Dec. 10, 2009

(54) ELECTROPHORETIC DISPLAY DEVICE, ELECTRONIC APPARATUS, AND METHOD OF DRIVING ELECTROPHORETIC DISPLAY DEVICE

(75) Inventors: Hiroshi MAEDA, Suwa (JP); Soichi MORIYA, Suwa (JP); Yasuhiro SHIMODAIRA, Munich (DE)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/430,248

(22) Filed: Apr. 27, 2009

(30) Foreign Application Priority Data
Jun. 9, 2008 (JP) 2008-150531
Jun. 10, 2008 (JP) 2008-152107

(51) Int. Cl. G09G 5/00; G09G 3/34

(52) U.S. Cl. 345/214; 345/107

(57) ABSTRACT

An electrophoretic display device includes a first substrate and a second substrate, an electrophoretic element which is placed between the first and second substrates and contains electrophoretic particles, a plurality of first pixel electrodes formed on an electrophoretic element side of the first substrate, second pixel electrodes provided on the electrophoretic element side of the first substrate in an electrically floating state, and a common electrode provided on an electrophoretic display side of the second substrate so as to face the first and second pixel electrodes, in which a region where the second pixel electrodes are placed includes part of a space between the adjacent first pixel electrodes.

### CROSS REFERENCES TO RELATED APPLICATIONS

The present invention contains subject matter related to Japanese Patent Application No. 2008-150531 and 2008-152107 filed in the Japanese Patent Office on Jun. 9, 2008 and Jun. 10, 2008, respectively, the entire contents of which are incorporated herein by reference.

### BACKGROUND

1. Technical Field

The present invention relates to an electrophoretic display device, an electronic apparatus including the electrophoretic display device, and a method of driving the electrophoretic display device.

2. Related Art

An electrophoretic display device using an electrophoretic element composed of a plurality of microcapsules, each encasing electrophoretic particles, as a display portion is known. For example, JP-A-2005-114822 discloses an active matrix electrophoretic display device having a structure in which an electrophoretic element is bonded onto an element substrate on which switching transistors and pixel electrodes are formed.

JP-A-2003-84314 discloses an active matrix electrophoretic display device having pixels, each provided with a switching element and a memory circuit.

In such kinds of electrophoretic display devices, after an image signal is written into the memory circuit via the pixel switching element in each pixel, the pixel electrode in the corresponding pixel is driven by potential according to the written image signal, and a potential difference between a common electrode and the pixel electrode is created. Thus, the electrophoretic element placed between the pixel electrode and the common electrode is driven to display an image.

The electrophoretic element is fixed to an element substrate having pixel electrodes and pixel circuits thereon by an adhesion layer, and the plurality of pixel electrodes having the same size and the rectangular shape is arranged in a matrix form.

However, as for the electrophoretic display device, since the pixel electrode has the rectangular shape, there is a problem in that an image is sharp-cornered when displaying the image supposed to have a smooth contour like a letter. That is, the image quality deteriorates. In greater detail, for example, in the case in which two adjacent pixels have values for displaying black and white, respectively, a halftone does not exist between the two pixels. Accordingly it is difficult to display a smooth contour.

Furthermore, in the case of displaying different tones by two adjacent pixels, a large potential difference is created between the pixel electrodes of the two pixels, resulting in leaking current between the pixels and increase in power consumption. In greater detail, the leaking current flows through the adhesion layer used for fixing the electrophoretic element to the element substrate.

### SUMMARY

It is an advantage of some aspects of the invention to provide an electrophoretic display device displaying an image of high quality, an electronic apparatus, and a driving method of an electrophoretic display device. It is another advantage of some aspects of the invention to provide an electrophoretic display device capable of suppressing power consumption.

In order to accomplish such advantages, according to one aspect of the invention, there is provided an electrophoretic display device including a first substrate and a second substrate, an electrophoretic element which is placed between the first and second substrates and contains electrophoretic particles, a plurality of first pixel electrodes formed on an electrophoretic element side of the first substrate, second pixel electrodes provided on the electrophoretic element side of the first substrate in an electrically floating state; and a common electrode provided on an electrophoretic display side of the second substrate so as to face the first and second pixel electrodes, in which the second pixel electrodes are placed at a region including a space between the adjacent first pixel electrodes.

With such a structure, during the operation, a voltage according to the image signal supplied via the data line is applied to the electrophoretic element interposed a pair of substrates for each pixel, and an image is displayed in the display portion composed of a plurality of pixels. In detail, for example, as the electrophoretic particles within the electrophoretic element move (i.e. migrate) according to the voltage applied between the first pixel electrodes and the second pixel electrodes formed on the first substrate which is an element substrate and the common electrode provided in a solid form on the second substrate which is an opposing substrate, the image corresponding to the moved electrophoretic particles is displayed on the second substrate side (i.e. the common electrode side) of the pair of substrate.

In the electrophoretic display device, the first pixel electrode is formed for each of first pixels specified according to intersections of scan lines and data lines of a plurality of pixels formed on the first substrate. Each of the first pixel electrodes is supplied with a pixel potential according to an image signal by a plurality of pixel circuits provided for the first pixels, respectively formed on the first substrate. That is, the pixel potential supplied via the data lines is supplied to the first pixel electrodes via the pixel circuits. Each of the pixel circuits includes, for example, a transistor serving as a pixel switching element, a memory circuit for maintaining an image signal supplied via the pixel switching element, and a switch circuit which changes the pixel potential supplied to the first pixel electrodes according to the output from the memory circuits.

On the other hand, each of the second pixel electrodes is placed at a space between adjacent first pixel electrodes. A bonding layer which bonds the electrophoretic element to the first substrate is typically provided between the first and second pixel electrodes on the first substrate. The bonding layer is provided so as to cover spaces between the first pixel electrodes and the second pixel electrodes from a point of a plan view of the first substrate. As the bonding layer is provided, leaking current flows between the first pixel electrodes and the second pixel electrodes. That is, the second pixel electrodes are provided with a potential according to a pixel potential supplied to the first pixel electrodes. The potential supplied to the second pixel electrodes is lower than the pixel potential supplied to the first pixel electrodes.

As the potential lower than the pixel potential is supplied to the second pixel electrodes due to the current leakage, in second pixels corresponding to the second pixel electrodes, it is possible to display a halftone of the color tones displayed in the first pixels corresponding to the first pixel electrodes. In detail, in the first pixels, as white particles and black particles inside an electrophoretic element which is, for example, a microcapsule move toward the first pixel electrode side or the common electrode side according to the voltage depending on the pixel potential applied between the first pixel electrode and the common electrode, white or black is displayed in the display portion. On the other hand, in the second pixels, since the voltage applied to the second pixels is lower as compared with the first pixels, the movement amount of the white particles and the black particles is reduced. Accordingly, in the second pixels, the white particles and the black particles cannot completely move to the second pixel electrode side and the common electrode side so as to display white or black. Accordingly, in the second pixels, gray which is the halftone between white and black is displayed.

The color tone of the halftone displayed in the second pixels (for example, a level of gray close to white or black) is determined by the pixel potential applied to the plurality of first pixel electrodes placed around the second pixel electrode.

As described above, according to the electrophoretic display device of the invention, since it is possible to display the halftone in the second pixels, it is possible to substantially increase levels of displayable color tone. Accordingly, it is possible to perform antialiasing by displaying the contour of the displayed image with the halftone, and therefore, it is possible to display the image with a smooth contour. Accordingly, it is possible to display an image of high quality.

Further, since the second pixel electrodes are placed at a region including a space between adjacent first pixel electrodes, it is possible to increase the distance between the adjacent first pixel electrodes. It is possible to reduce influence of the potential difference between the pixel electrodes by increasing the distance adjacent first pixel electrodes, and therefore it is possible to suppress the current leakage. Accordingly, it is possible to suppress the increase in the power consumption.

In the electrophoretic display device, it is preferable that the second pixel electrodes are placed to surround the first pixel electrodes in a plan view.

In the electrophoretic display device, it is preferable that the electrophoretic display device further includes a plurality of scan lines and a plurality of data lines provided on the first substrate so as to intersect with each other, and a pixel circuit connected to the first pixel electrode for supplying a pixel potential according to an image signal supplied via the data line to the first pixel electrode, in which the first pixel electrodes are placed on the first substrate so as to form a matrix corresponding to intersections of the plurality of scan lines and the plurality of data lines, and in which the second pixel electrodes are placed at the region including any one of a space between the first pixel electrodes adjacent to each other in a row direction of the matrix, a space between the first pixel electrodes adjacent to each other in a column direction of the matrix, or a space between the first pixel electrodes adjacent to each other in an oblique direction with respect to the row direction and the column direction.

With such a structure, since the second pixel electrode (floating electrode) is provided between the adjacent first pixel electrodes in a row direction and a column direction, the gap between the adjacent pixel electrodes increases and therefore it is possible to suppress the current leakage.

Furthermore, it is possible to display in the space between rows of the first pixel electrodes and the space between columns of the first pixel electrodes.

In the electrophoretic display device, it is preferable that the second pixel electrode is placed at a region surrounded by adjacent four first pixel electrodes arranged in two rows and two columns.

In the present specification, “region surrounded by first pixel electrodes” means a portion of an inside area of a polygonal shape (typically quadrangular shape) formed by connecting points (for example center points) of the plurality of adjacent first pixel electrodes to each other, in which the region is other than an area in which the first pixel electrodes are formed. Accordingly, the second pixel electrodes are formed to be at least partially surrounded by the first pixel electrodes in a plan view on the first substrate. Each of the second pixel electrodes is electrically floating.

With such a structure, the color tone of the halftone displayed in the second pixel electrodes (for example, a level of gray close to white or black) is determined by the pixel potential applied to a plurality of first pixel electrodes surrounding the second pixel electrode. For example, the color tone of the halftone displayed in a single second pixel is almost determined by the pixel potential applied to four first pixel electrodes provided for four first pixels, respectively, which are adjacent to the second pixel. That is, if the pixel potential for displaying white is supplied to two first pixel electrodes of four first pixel electrodes, and the pixel potential for displaying black is supplied to the remaining two first pixel electrodes, gray which is substantially the half between the black and white is displayed in the second pixel. If the pixel potential for displaying white is supplied to three first pixel electrodes of four first pixel electrodes and the pixel potential for displaying black is supplied to the remaining one first pixel electrode, gray closer to white is displayed in the second pixel. If the pixel potential for displaying white is supplied to one of four first pixel electrodes and the pixel potential for displaying black is supplied to the remaining three first pixel electrodes, gray closer to black is displayed in the second pixel.

In the case in which all of four first pixel electrodes are supplied with the pixel potential for displaying black, black which is perfectly or almost the same as the display of the first pixel is displayed in the second pixel. In a similar manner, all of four first pixel electrodes are supplied with the pixel potential for displaying white, the white which is perfectly or almost the same as the display of the first pixel is display in the second pixel. That is, the second pixel can display the color tone which can be displayed by the first pixel besides the halftone.

In the electrophoretic display device, it is preferable that the first and second pixel electrodes have substantially the same size from a point of a plan view of the first substrate.

With such a structure, since the size of the first and second pixel electrodes are substantially the same as each other from a point of a plan view of the first substrate, it is possible to easily form the first and second pixel electrodes. The size of the first pixel displaying an image according to the pixel potential can be substantially the same as the size of the second pixel displaying the halftone. Accordingly, as the first and second pixels are different from each other in their sizes, it is possible to prevent smoothness of the display image from deteriorating. Further, “the same” in this specification does not mean perfectly the same. That is, the same means the state in which sizes are similar with each other to the extent that the above advantages can be obtained. In other words, even by the means in which the sizes of the first and second pixel electrodes are similar with each other, the advantages of this embodiment can be obtained.

In the electrophoretic display device, it is preferable that the second pixel electrode is larger than the first pixel electrode in a plan view of the first substrate.

With such a structure, since the second pixel electrodes are formed to be larger than the first pixel electrodes in a plan view on the first substrate, the second pixel displaying the halftone becomes larger than the first pixel displaying the image according to the pixel potential. With such a structure, it is possible to further smooth the contour of the displayed image.

In the electrophoretic display device, it is preferable that the second pixel electrode is smaller than the first pixel electrode in a plan view on the first substrate.

With such a structure, since the second pixel electrode is smaller than the first pixel electrode in a plan view on the first substrate, the second pixel displaying the halftone becomes smaller than the first pixel displaying the image according to the pixel potential. For such a reason, it is possible to improve contrast of the displayed image.

In the electrophoretic display device, it is preferable that each of the first pixel electrode and the second pixel electrode has a quadrangular shape whose four sides are oblique to the direction in which the data lines extend in a plan view on the first substrate.

According to the structure, each of the first and second pixel electrodes has a quadrangular shape whose sides are oblique to a direction in which the data lines extend in a plan view on the first substrate. Accordingly, the first and second pixel electrodes can be properly placed as compared with the case of having the quadrangular shape whose sides are not oblique to the direction in which the data lines extend. In detail, it is possible to prevent the gap between the first and second pixel electrodes from becoming too large, and it is easy to place the first pixel electrodes in a manner of surrounding the second pixel electrode. From this point of view, it is preferable that each of the first pixel electrode and the second pixel electrode is a square shape whose sides are oblique to the data lines at an angle of 45°. Further, as each of sides of each of the first and second pixel electrodes is oblique, it is possible to further smooth the contour of the displayed image which extends in the oblique direction.

In the electrophoretic display device, it is preferable that at least either the first pixel electrodes or the second pixel electrodes have a circular shape in a plan view on the first substrate.

With such a structure, since at least one kind of the first pixel electrodes and the second pixel electrodes have a circular shape in a plan view on the first substrate, the first and second pixel electrodes have a structure with no sharp-corners. Accordingly, as for the contour of the displayed image, it is possible to prevent the unevenness from occurring attributable to the corners of the first and second pixel electrodes and prevent the image quality from deteriorating. The term “circular shape” includes an oval shape as well as a circle. Furthermore, as the shape is a polygonal shape closer to the circular shape than a rectangular shape like an octagonal shape or a star shape, the above advantage can be obtained.

In order to accomplish the advantage of the invention, according to another aspect of the invention, there is provided an electronic apparatus including the above electrophoretic display device (including the above-mentioned plural kinds of electrophoretic display device)

According to such an electronic apparatus, as it is equipped with the above-described electrophoretic display device, it is possible to realize various kinds of electronic apparatuses such as a wrist watch, electronic paper, an electronic note, a cellular phone, and a portable audio machine which can display the image of high quality.

According to a further aspect of the invention, there is provided a driving method of a first electrophoretic display device. The driving method is a driving method of an electrophoretic display device having a structure in which an electrophoretic element including electrophoretic particles is interposed between a first substrate and a second substrate. The electrophoretic display device further includes a plurality of scan lines and data lines provided to intersect each other on the first substrate, first pixel electrodes placed on an electrophoretic element side of the first substrate while forming a matrix corresponding to intersections of the scan lines and data lines, pixel circuits connected to the first pixel electrodes for supplying a pixel potential depending on an image signal supplied via the data lines to the first pixel electrodes, second pixel electrodes provided in an electrically floating state at a region including any one of a space between adjacent first pixel electrodes in a row direction of the matrix, a space between adjacent first pixel electrodes in a column direction of the matrix, or a space between adjacent first pixel electrodes in an oblique direction with respect to the row direction and the column direction on an electrophoretic element side of the first substrate, and a common electrode provided on an electrophoretic element side of the second substrate so as to face the first pixel electrodes and the second pixel electrodes. The driving method includes an image writing-in step of supplying either a first potential or a second potential lower than the first potential as a pixel potential to each of the plurality of the first pixel electrodes and repeatedly supplying a potential equal to the first potential and a potential equal to the second potential to the common electrode as a common potential in a predetermined period during an image writing-in period, a halftone creating step of displaying a halftone in a pixel by supplying either the first potential or the second potential to each of the plurality of first pixel electrodes as the pixel potential and repeatedly supplying a potential equal to the first potential and a potential equal to the second potential to the common electrode as the common potential in a period shorter than the predetermined period during a halftone creating period continuing from the image writing-in period, and an image maintaining step of causing the first pixel electrodes and the common electrode to fall into a high impedance state in which the first pixel electrodes and the common electrode are electrically disconnected during an image maintaining period continuing from the halftone creating period.

According to such a driving method, in the image writing-in period, each of the plurality of first pixel electrodes is supplied with a first potential or a second potential lower than the first potential as a pixel potential and the common electrodes is repeatedly supplied with a potential equal to the first potential or a potential equal to the second potential as a common potential in predetermined periods. For this reason, pixels corresponding to the first pixel electrodes supplied with the first potential are not applied with a voltage when the common potential are equal to the first potential but applied with a voltage only when the common potential is equal to the second potential. In this manner, pixels corresponding to the first pixel electrodes supplied with the second potential are not applied with a voltage when the common potential is equal to the second potential, but applied with a voltage only when the common potential is equal to the first potential.

In the subsequent halftone creating period, each of the plurality of first pixel electrodes is supplied with either the first potential or the second potential as the pixel potential and the common electrode is repeatedly supplied with a potential equal to the first potential and a potential equal to the second potential as the common potential in periods shorter than predetermined periods. In this manner, the halftone (i.e. a color tone between the color tone corresponding to the first potential and the color tone corresponding to the second potential) is displayed in the second pixels.

In the subsequent image maintaining period, each of the first pixel electrodes and the common electrodes fall to the high impedance state in which they are electrically disconnected. That is, in the image maintaining period, since a voltage is not applied between the first pixel electrodes and the common electrode and between the second pixel electrodes and the common electrode, the image displayed in the display portion is maintained in the image writing-in period and the halftone creating period.

In this invention, as described above, in the halftone creating period, since the common electrode is repeatedly supplied with a potential equal to the first potential and a potential equal to the second potential in periods shorter than predetermined periods, during a period of time by the image maintaining period in which the voltage is not applied, a period of time in which electrophoretic particles in the electrophoretic element move (are drawn) to the first and second pixel electrode side and the common electrode side becomes shorter. Accordingly, in second pixels supposed to display the halftone, it is possible to prevent the halftone from not being able to be displayed attributable to the phenomenon that the electrophoretic particles move too much.

In detail, in the second pixels displaying the halftone, every time when the common potential changes in predetermined periods, the electrophoretic particles inside the electrophoretic element move different sides. That is, the electrophoretic particles are drawn to different sides in the case in which the common potential is a potential equal to the first potential and the case in which the common potential is a potential equal to the second potential. If the halftone creating period is not provided and the image maintaining period is subsequent to the image writing-in period, the electrophoretic particles inside the electrophoretic element are drawn to and maintained at either the first and second pixel electrode side or the common electrode side for a relatively long time. In this case, the color tones displayed in the second pixels become close to the color tone according to the first potential and the color tone according to the second potential, and therefore there is the possibility that the displayed tone is different from the halftone supposed to display.

In this invention, since the halftone creating period is provided, a period of time in which the electrophoretic particles inside the electrophoretic element move is shortened. Accordingly, the electrophoretic particles are maintained at a position close to a middle point between the first pixel electrode and the common electrode and between the second pixel electrode and the common electrode. Accordingly, the second pixel displays the halftone.

The halftone creating period is very short as compared with the image writing-in period and is determined according to the levels of the applied first and second potentials and the movement amount (easiness of movement) of the electrophoretic particles in the electrophoretic element.

As described above, according to a driving method of a first electrophoretic display device, it is possible to surely display the halftone in the second pixels. Accordingly, it is possible to display the image of high quality.

According to a still further aspect of the invention, there is provided a driving method of a second electrophoretic display device structured such that an electrophoretic element containing electrophoretic particles is interposed between a first substrate and a second substrate, in which the electrophoretic display device includes a plurality of scan lines and a plurality of data lines provided on the first substrate so as to intersect each other, first pixel electrodes placed on an electrophoretic element side of the first substrate so as to form a matrix corresponding to intersections of the plurality of scan lines and the plurality of data lines, a pixel circuit connected to the first pixel electrode for supplying a pixel potential according to an image signal supplied via the data line to the first pixel electrode, a second pixel electrode provided in an electrically floating state at a region including any one of a space between the first pixel electrodes adjacent to each other in a row direction of the matrix, a space between the first pixel electrodes adjacent to each other in a column direction of the matrix, or a space between the first pixel electrodes adjacent to each other in an oblique direction with respect to the row direction and the column direction, at a portion on the electrophoretic element side on the first substrate, and a common electrode provided on an electrophoretic element side of the second substrate so as to face the first and second pixel electrodes, and in which the driving method includes an image writing-in step of supplying either a first potential or a second potential lower than the first potential to each of the plurality of the first pixel electrodes as a pixel potential and repeatedly supplying a potential equal to the first potential and a potential equal to the second potential to the common electrode as a common potential in predetermined periods during an image writing-in period, a halftone creating step of displaying a halftone in a second pixel by supplying either the first potential or the second potential to each of the plurality of first pixel electrodes as the pixel potential and repeatedly supplying a third potential lower than the first potential and a fourth potential higher than the second potential and lower than the third potential to the common electrode as the common potential in periods shorter than the predetermined periods during a halftone creating period continuing from the image writing-in period, and an image maintaining step of causing the first pixel electrodes and the common electrode to fall to a high impedance state in which the first pixel electrodes and the common electrode are electrically disconnected during an image maintaining period continuing from the halftone creating period.

According to this driving method, like the driving method of the first electrophoretic display device, in the image writing-in period, each of the plurality of first pixel electrodes is supplied with either the first potential or the second potential lower than the first potential as a pixel potential and the common electrode is repeatedly supplied with a potential equal to the first potential and a potential equal to the second potential in predetermined periods.

In the subsequent halftone creating period, each of the plurality of first pixel electrodes is supplied with either the first potential or the second potential as the pixel potential and the common electrode is repeatedly supplied with a third potential lower than the first potential and a fourth potential lower than the third potential and higher than the second potential in periods shorter than predetermined periods as a common potential.

In the image maintaining period, the first pixel electrodes and the common electrode fall to the high impedance state in which they are electrically disconnected. That is, in the image maintaining period, since a voltage is applied between the first pixel electrodes and the common electrode and between the second pixel electrodes and the common electrode, the image displayed in the display portion is maintained in the image writing-in period and the halftone creating period.

In this invention, in the halftone creating period, since the common electrode is repeatedly supplied with the third potential and the fourth potential in periods shorter than the predetermined periods, like the driving method of the above-mentioned first electrophoretic display device of the invention, during a period of time by the image maintaining period in which the voltage is not applied, force of drawing the electrophoretic particles decreases as a period of time in which the electrophoretic particles in the electrophoretic element move (are drawn) toward the first and second pixel electrodes and the common electrode becomes shorter. That is, as a voltage applied between the first pixel electrode and the common electrode and between the second pixel electrode and the common electrode is lowered, it becomes hard for the electrophoretic particles to move. Accordingly, in the second pixels supposed to display the halftone, it is possible to effectively prevent the phenomenon in which the halftone cannot be displayed as the electrophoretic particles move too much.

As described above, according to the driving method of the second electrophoretic display device, like the above-mentioned driving method of the first electrophoretic display device, it is possible to surely display the halftone in the second pixels. Accordingly, it is possible to display the image of high quality.

### BRIEF DESCRIPTION OF THE DRAWINGS

The invention will be described with reference to the accompanying drawings, wherein like numbers reference like elements.

FIG. 1 is a block diagram illustrating the entire structure of an electrophoretic display device according to a first embodiment.

FIG. 2 is an equivalent circuit diagram illustrating an electrical structure of a pixel.

FIG. 3 is a plan view illustrating arrangement of first pixel electrodes and second pixel electrodes.

FIG. 4 is a partial sectional view illustrating a display portion of the electrophoretic display device.

FIG. 5 is a schematic view illustrating structure of a microcapsule.

FIG. 6 is a timing chart illustrating a driving method of the electrophoretic display device.

FIG. 7 is a plan view conceptually illustrating color tones of pixels of the electrophoretic display device.

FIG. 8 is a conceptual view illustrating contribution of surrounding first pixel electrodes to second pixel electrodes.

FIG. 9 is a timing chart illustrating a first modification of the driving method of the electrophoretic display device.

FIG. 10 is a timing chart illustrating a second modification of the driving method of the electrophoretic display device.

FIG. 11 is a plan view conceptually illustrating color tones of pixels of an electrophoretic display device according to a second embodiment.

FIG. 12 is a plan view illustrating a modification of the electrophoretic display device.

FIG. 13 is a plan view conceptually illustrating color tones of pixels of an electrophoretic display device according to a third embodiment of the invention.

FIG. 14 is a conceptual view illustrating contribution of surrounding first and second pixel electrodes to potential of the second pixel electrode.

FIG. 15 is a block diagram illustrating schematic structure of an electrophoretic display device according to a fourth embodiment.

FIG. 16 is a plan a view illustrating arrangement of first and second pixel electrodes.

FIG. 17 is a partial sectional view illustrating a display portion of an electrophoretic display device.

FIG. 18 is a sectional view illustrating operation of applying a voltage to adjacent first pixel electrodes.

FIG. 19 is a view illustrating a pixel circuit according to anther aspect.

FIG. 20 is a view illustrating a pixel circuit according to a further aspect.

FIG. 21 is a perspective view illustrating structure of electronic paper.

FIG. 22 is a perspective view illustrating structure of an electronic note.

### DESCRIPTION OF EXEMPLARY EMBODIMENTS

### First Embodiment

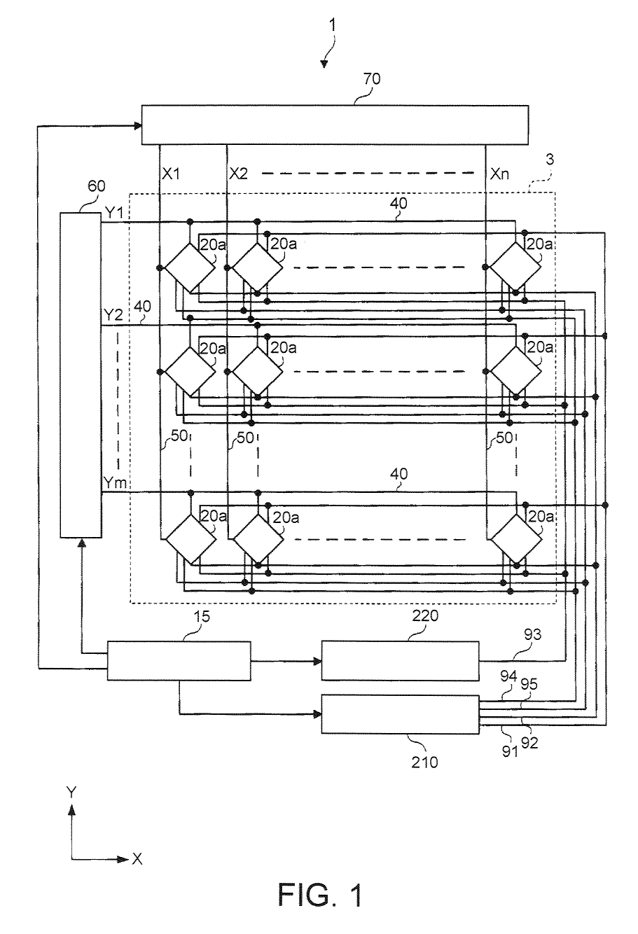

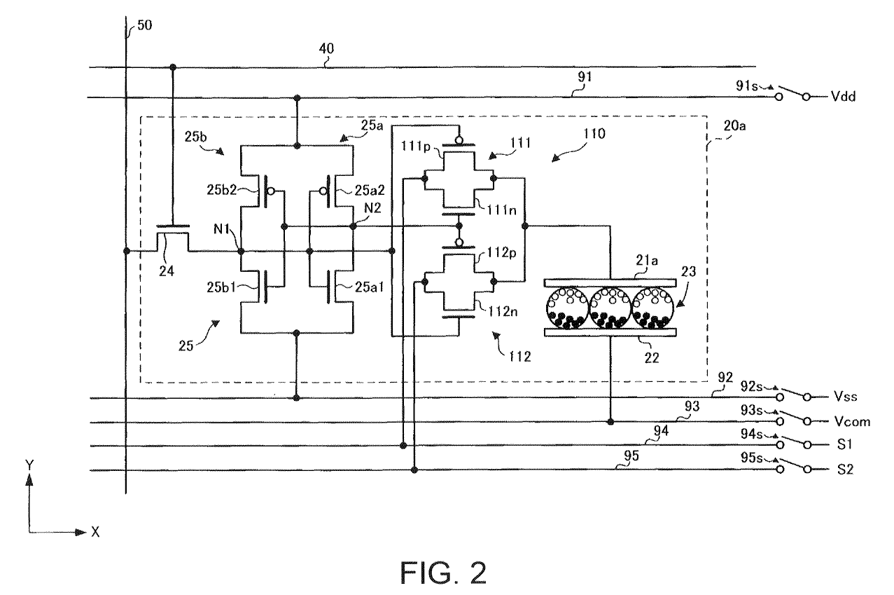

First, the entire structure of an electrophoretic display device according to a first embodiment will be described with reference to FIGS. 1 and 2.

FIG. 1 is a block diagram illustrating the entire structure of an electrophoretic display device according to a first embodiment. As shown in FIG. 1, the electrophoretic display device 1 according to this embodiment includes a display portion 3, a controller 15, a scan line drive circuit 60, a data line drive circuit 70, a power supply circuit 210, and a common potential supply circuit 220.

The display portion 3 has a matrix form in which m rows and n columns of first pixels 20a are arranged on a two-dimensional surface. The display portion 3 is provided with m scan lines 40 (i.e. scan lines Y1, Y2, . . . , and Ym) and n data lines 50 (i.e. data lines X1, X2, . . . , and Xn) arranged so as to intersect to each other. In greater detail, the m scan lines 40 extend in a row direction (i.e. X direction) and the n data lines 50 extend in a column direction (i.e. Y direction). First pixels 20a are placed corresponding to intersections of the m scan lines 40 and the n data lines 50. As described below, each first pixel 20a is provided with a first pixel electrode 21a having a square shape whose sides are oblique to the scan lines 40 and the data lines 50 at an angle of 45°.

Furthermore, although it is omitted in illustration, each of second pixels corresponding to regions, each surrounded by the first pixels 20a (i.e. region surrounded by two scan lines 40 and two data lines 50), is provided with a second pixel electrode 21b. The second pixel electrodes 21b will be described below.

The scan line drive circuit 60 sequentially supplies scan signals in a pulse form to the scan lines Y1, Y2, . . . , and Ym in response to timing signals. The data line drive circuit 70 supplies image signals to the data lines X1, X2, . . . , and Xn in response to timing signals. Each of the image signals is a binary level signal composed of a high potential level (hereinafter referred to as “high level”, for example 5V) or a low potential level (hereinafter, referred to as “low level”, for example 0V).

Each of the first pixels 20a is electrically connected to a high potential power source line 91, a low potential power source line 92, a common potential line 93, a first control line 94, and a second control line 95. Each of the high potential power source line 91, the low potential power source line 92, the common potential line 93, the first control line 94, and the second control line 95 is typically connected to the first pixel electrodes 21a of pixels which belong to a pixel column and are arranged in the row direction (X direction) in common for each of pixel columns as shown in FIG. 1.

FIG. 2 is an equivalent circuit view illustrating electrical structure of a pixel.

In FIG. 2, each of the first pixels 20a corresponding to the first pixel electrodes 21a includes a pixel switching transistor 24, a memory circuit 25, a switch circuit 110, a first pixel electrode 21a, a common electrode 22, and an electrophoretic element 23. The pixel switching transistor 24, the memory circuit 25, and the switch circuit 110 constitute an example of “pixel circuit” of the invention.

The pixel switching transistor 24 is formed of, for example, an N-type transistor. The pixel switching transistor 24 is electrically connected to the scan line 40 at its gate, to the data line 50 at its source, and to an input terminal N1 of the memory circuit at its drain. The pixel switching transistor 24 outputs an image signal supplied via the data line 50 from the data line drive circuit 70 (see FIG. 1) to the input terminal N1 of the memory circuit 25 at timing according to the scan signal and is supplied from the scan line drive circuit 60 (see FIG. 1) via the scan line 40 in a pulse form.

The memory circuit 25 is composed of, for example, inverter circuits 25a and 25b and is formed as a structure of an static random access memory (SRAM)

The inverter circuits 25a and 25b has a loop structure in which output terminals of the inverters are electrically connected to input terminals of the counter inverters, respectively. That is, the input terminal of the inverter circuit 25a is electrically connected to the output terminal of the inverter circuit 25b, and the input terminal of the inverter circuit 25b is electrically connected to the output terminal of the inverter circuit 25a. The input terminal of the inverter circuit 25a serves as an input terminal N1 of the memory circuit 25 and the output terminal of the inverter circuit 25a serves as the output terminal N2 of the memory circuit 25.

The inverter circuit 25a includes an N-type transistor 25a1 and a P-type transistor 25a2. Gates of the N-type transistor 25a1 and the P-type transistor 25a2 are electrically connected to the input terminal N1 of the memory circuit 25. A source of the N-type transistor 25a1 is electrically connected to the low potential power source line 92 via which a low power source potential Vss is supplied. A source of the P-type transistor 25a2 is electrically connected to a high potential power source line 91 via which a high power source potential Vdd is supplied. Drains of the N-type transistor 25a1 and the P-type transistor 25a2 are electrically connected to the output terminal N2 of the memory circuit 25.

The inverter circuit 25b includes an N-type transistor 25b1 and a P-type transistor 25b2. Gates of the N-type transistor 25b1 and the P-type transistor 25b2 are electrically connected to the output terminal N2 of the memory circuit 25. A source of the N-type transistor 25b1 is electrically connected to the low potential power source line 92 via which the low power source potential Vss is supplied. A source of the P-type transistor 25b2 is electrically connected to the high potential power source line 91 via which the high power source potential Vdd is supplied. Drains of the N-type transistor 25b1 and the P-type transistor 25b2 are electrically connected to the input terminal N1 of the memory circuit 25.

The memory circuit 25 outputs the low power source potential Vss from the output terminal N2 when the image signal of a high level is input to the input terminal N1 thereof, and outputs the high power source potential Vdd from the output terminal N2 when the image signal of a low level is input to the input terminal N1 thereof. That is, the memory circuit 25 outputs either the low power source potential Vss or the high power source potential Vdd according to whether the input image signal is the high level or the low level. In other words, the memory circuit 25 is structured so as to be able to store the input image signal as the low power source potential Vss or the high power source potential Vdd.

The high potential power source line 91 and the low potential power source line 92 are structured in a manner such that the low power source potential Vss and the high power source potential Vdd can be supplied via the power source lines 91 and 92, respectively from the power supply circuit 210. The high potential power source line 91 is electrically connected to the power supply circuit 210 via a switch 91s, and the low potential power source line 92 is electrically connected to the power supply circuit 210 via a switch 92s. The switches 91a and 92s are structured to change between an on-state and an off-state by the controller 15. As the switch 91s changes to the on-state, the high potential power source line 91 and the power supply circuit 210 are electrically connected to each other while as the switch 91s changes to the off-state, the high potential power source line 91 falls to a high impedance state in which the high potential power source line 91 is electrically disconnected. On the other hand, as the switch 92s changes to the on-state, the low potential power source line 92 and the power supply circuit 210 are electrically connected to each other while as the switch 92s changes to the off-state, the low potential power source line 92 falls to the high impedance state in which the low potential power source line 92 is electrically disconnected.

The switch circuit 110 includes a first transmission gate 111 and a second transmission gate 112.

The first transmission gate 111 includes a P-type transistor 111p and an N-type transistor 111n. Sources of the P-type transistor 111p and the N-type transistor 111n are electrically connected to the first control line 94. Drains of the P-type transistor 111p and the N-type transistor 111n are electrically connected to the pixel electrode 21. A gate of the P-type transistor 111p is electrically connected to the input terminal N1 of the memory circuit 25, and a gate of the N-type transistor 111n is electrically connected to the output terminal N2 of the memory circuit 25.

The second transmission gate 112 includes a P-type transistor 112p and an N-type transistor 112n. Sources of the P-type transistor 112p and the N-type transistor 112n are electrically connected to the second control line 95. Drains of the P-type transistor 112p and the N-type transistor 112n are electrically connected to the pixel electrode 21. A gate of the P-type transistor 112p is electrically connected to the output terminal N2 of the memory circuit 25, and a gate of the N-type transistor 112n is electrically connected to the input terminal N1 of the memory circuit 25.

The switch circuit 110 selects either the first control line 94 or the second control line 95 in response to the image signal input to the memory circuit 25 and thus makes either one of the control lines be electrically connected to the pixel electrode 21.

In greater detail, when the image signal of high level is input to the input terminal N1 of the memory circuit 25, the low power source potential Vss is output to the gates of the N-type transistor 111n and the P-type transistor 112p from the memory circuit 25 and the high power source potential Vdd is output to the gates of the P-type transistor 111p and the N-type transistor 112n. As a result, only the P-type transistor 112p and the N-type transistor 112n constituting the second transmission gate 112 turn to the on-state while the P-type transistor 111p and the N-type transistor 111n constituting the first transmission gate 111 change to the off-state. Conversely, when the image signal of low level is input to the input terminal N1 of the memory circuit 25, the high power source potential Vdd is output to the gates of the N-type transistor 111n and the P-type transistor 112p and the low power source potential Vss is output to the gates of the P-type transistor 111p and the N-type transistor 112n from the memory circuit 25. As a result, only the P-type transistor 111p and the N-type transistor 111n constituting the first transmission gate 111 change to the on-state while the P-type transistor 112p and the N-type transistor 112n constituting the second transmission gate 112 change to the off-state. That is, in the case in which the image signal of high level is input to the input terminal N1 of the memory circuit 25, only the second transmission gate 112 changes to the on-state. On the other hand, in the case in which the image signal of low level is input to the input terminal N1 of the memory circuit 25, only the first transmission gate 111 changes to the on-state.

The first pixel electrode 21a is electrically connected to the first control line 94 or the second control line 95 which is alternately selected in response to the image signal by the switch circuit 110. At such time, according to the on-state or the off-state of the switch 94s or 95s, the potential S1 or the potential S2 is supplied to the first pixel electrode 21a. Alternatively, the first pixel electrode 21a falls to the high impedance state.

The first pixel electrodes 21a are placed to face the common electrode 22 with the electrophoretic elements 23 interposed therebetween. The common electrode 22 is electrically connected to the common potential line 93 to which the common potential Vcom is supplied. The common potential line 93 is structured in a manner such that the common potential Vcom can be supplied thereto from the power supply circuit 210. The common potential line 93 is electrically connected to the common potential supply circuit 220 via the switch 93s. The switch 93s is structured so as to change between the on-state and the off-state by the controller 15. As the switch 93s changes to the on-state, the common potential line 93 and the common potential supply circuit 220 are electrically connected to each other. On the other hand, as the switch 93s changes to the off-state, the common potential line 93 falls to the high impedance state in which the common potential line 93 is electrically disconnected.

In this embodiment, the first control line 94 supplies the common potential Vcom as a potential S1. The second control line 95 supplies a potential S2 with a first potential VH (for example, 15V) and a second potential VL (for example, 0V). The first control line 94 and the second control line 95 may be structured in a manner such that each of them supplies the common potential Vcom, the first potential VH, and the second potential VL. That is, it is sufficient that three kinds of potentials (the common potential Vcom, the first potential VH, and the second potential VL) can be supplied by the first control line 94 and the second control line 95. Moreover, the change of the potentials is performed by the power supply circuit 210 to which the first control line 94 and the second control line 95 are connected.

When supplying the potentials, as for the pixels 20 to which the image signal of low level is supplied, only the first transmission gate 111 is turned on. Therefore, the first pixel electrodes 21a of the pixels 20 are electrically connected to the first control line 94 and thus supplied with the potential S1 from the power supply circuit 210 or the first pixel electrodes 21a of the pixels 20 fall to the high impedance state according to the on/off-state of the switch 94s. On the other hand, as for the pixels 20 to which the image signal of high level is supplied, only the second transmission gate 112 is turned on. Therefore, the first pixel electrodes 21a of the pixels 20 are electrically connected to the second control line 95 and thus supplied with the potential S2 from the power supply circuit 210, or the first pixel electrodes 21a of the pixels 20 fall to the high impedance state according to the on/off-state of the switch 95s.

Each of the electrophoretic elements 23 is composed of a plurality of microcapsules, each containing electrophoretic particles therein.

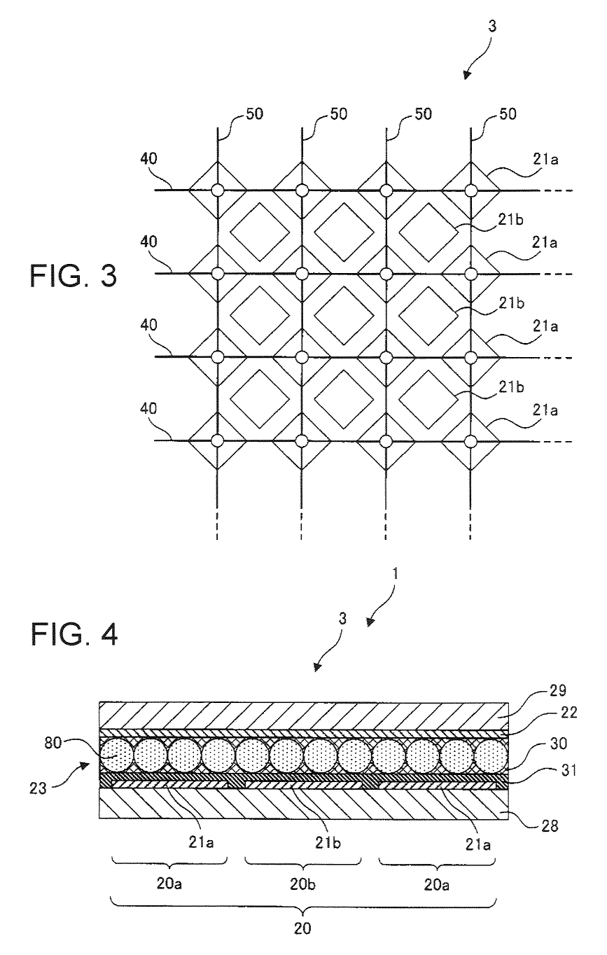

Next, a display portion of the electrophoretic display device according to this embodiment will be described in detail with reference to FIGS. 3, 4, and 5.

FIG. 3 is a plan view showing arrangement of the first pixel electrodes and the second pixel electrodes. In FIG. 3, for the sake of simplicity, circuits and wirings shown in FIG. 1 are omitted in the illustration.

In FIG. 3, the display portion 3 of the electrophoretic display device according to this embodiment further includes second pixel electrodes 21b besides the first pixel electrodes 21a. Each of the second pixel electrodes 21b is placed at a region surrounded by four first pixel electrodes 21a arranged in two rows and two columns. In other words, each of the second pixel electrodes 21b is placed between adjacent rows of the first pixel electrodes 21a or between adjacent columns of the first pixel electrodes 21a. From a different point of view, each of the second pixel electrodes 21b is placed inside a rectangular region formed by drawing lines to connect centers of adjacent four first pixel electrodes 21a placed in two rows and two columns. In particular, each of the second pixel electrodes 21b is placed at a portion of the rectangular region other than an area at which the first pixel electrode 21a is formed. From a further different point of view, each of the second pixel electrodes 21b is placed at a region including an intersection point of diagonal lines of a rectangle formed by drawing lines to connect the centers of the four first pixel electrodes 21a when viewing four first pixel electrodes 21a arranged to adjacent to each other in two rows and two columns. From a still further different point of view, each of the second pixel electrodes 21b is placed at a space between the first pixel electrodes 21a adjacent to each other in an oblique direction with respect to the row direction and the column direction. As a result, the second pixel electrodes 21b may be placed in a matrix at a region surrounded by two scan lines 40 and two data lines 50. The second pixel electrode 21b has the same size and shape as the first pixel electrode 21a. That is, the second pixel electrode 21b has a square shape whose sides are oblique to the scan line 40 and the data line 50 at an angel of 45°.

In this embodiment, the second pixel electrodes 21b are in an electrically floating state. In other words, the pixel switching transistor 24, the memory circuit 25, and the switch circuit 110 are provided for every first pixel electrode 21a but not provided for the second pixel electrodes 21b. Accordingly, each of the second pixel electrodes 21b is not supplied with the first potential and the second potential according to the image signal supplied via the data line 50.

FIG. 4 is a partial sectional view illustrating a display portion of an electrophoretic display device according to a first embodiment.

In FIG. 4, the display portion 3 has a structure in which electrophoretic elements 23 are interposed between an element substrate 28 and an opposing substrate 29. This embodiment premises that an image is displayed on the opposing substrate 29 side.

The element substrate 28 is a substrate made of, for example, glass, plastic, or the like. Although illustration is omitted in the figures, the element substrate 28 has a laminate structure in which the pixel switching transistors 24, the memory circuits 25, the switching circuit 110, the scan lines 40, the data lines 50, the high potential power source line 91, the low potential power source line 92, the common potential line 93, the first control line 94, and the second control line 95 which are described above with reference to FIG. 2 are formed. A plurality of first pixel electrodes 21a and a plurality of second pixel electrodes 21b are provided in a matrix on the uppermost layer of the laminate structure. The first pixel electrodes 21a are provided to first pixels 20a, respectively of a plurality of pixels 20, and the second pixel electrodes 21b are provided to second pixels 20b, respectively of the plurality of pixels 20.

The opposing substrate 29 is a transparent substrate made of, for example, glass, plastic, or the like. A surface of the opposing substrate 29 which faces the element substrate 28 is provided with the common electrode 22 in a solid form while facing the plurality of pixel electrodes 21a. The common electrode 22 is made of a transparent conductive material, such as magnesium silver (MgAg), indium tin oxide (ITO), indium zinc oxide (IZO), and etc.

Each of the electrophoretic elements 23 is composed of a plurality of microcapsules 80, each containing electrophoretic particles therein. For example, the electrophoretic elements 23 are fixed between the element substrate 28 and the opposing substrate 29 by a binder 30 made of, for example, resin and a bonding layer 31. The electrophoretic display device 1 according to this embodiment is formed in a manner such that an electrophoretic sheet formed in a manner such that the electrophoretic elements 23 are fixed to the opposing substrate 29 by the binder 30 in advance is bonded to the element substrate 28 which is provided with the first pixel electrodes 21a and the second pixel electrodes 21b and manufactured in advance by the bonding layer 31 in a manufacturing process. The bonding layer 31 is provided so as to cover at least gaps between the first pixel electrodes 21a and the second pixel electrodes 21b in a plan view of the element substrate 28, and is formed so as to cover the whole area at which the display portion is formed on the element substrate 28 (i.e. the area provided with the first pixel electrodes 21a and the second pixel electrodes 21b).

Since the bonding layer 31 contains a very small amount of moisture, leaking current flows between the first pixel electrodes 21a and the second pixel electrodes 21b via the bonding layer 31. As a result, the first potential and the second potential supplied to the first pixel electrodes 21a are partially supplied to the second pixel electrodes 21b. That is, the bonding layer 31 according to the embodiment can be made of a conductive layer having lower conductivity than that of the first pixel electrodes 21a and the second pixel electrodes 21b. Each of the second pixel electrodes 21b applies the potential supplied via the bonding layer 31 to the corresponding pixel 20.

The microcapsules 80 are interposed between the pixel electrodes 21 and the common electrode 22. A single microcapsule or a plurality of microcapsules is placed in a single pixel 20 (for example, with respect to a single pixel electrode 21).

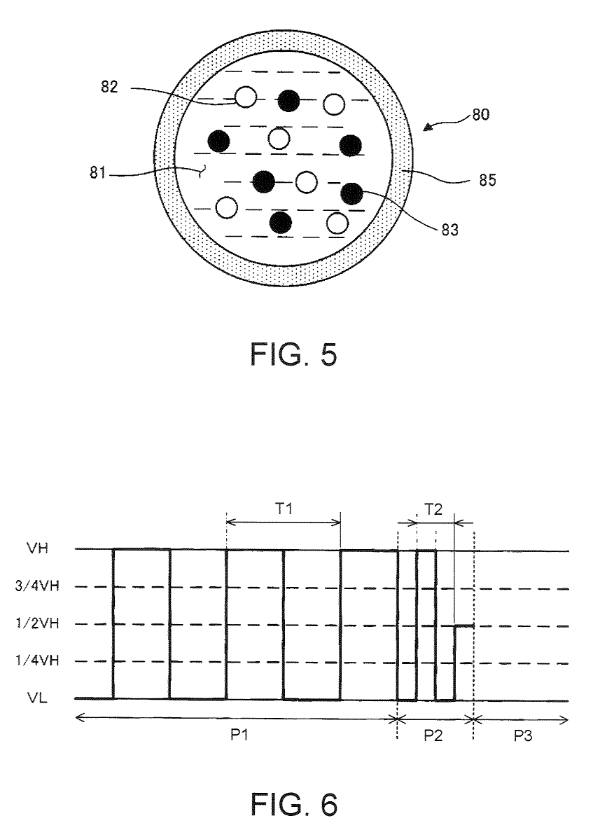

FIG. 5 is a schematic view illustrating structure of the microcapsule. FIG. 5 schematically shows the section of the microcapsule.

In FIG. 5, the microcapsule 80 includes a dispersion medium 81, a plurality of white particles 82, and a plurality of black particles 83 sealed in a capsule 85. The microcapsule 80 has a spherical shape having a particle size of about 50 μm. The white particles 82 and the black particles 83 are examples of “electrophoretic particles” according to the invention.

The capsule 85 serves as a shell of the microcapsule 80 and is made of transparent polymer resin, for example, polymethylmethacrylate, acryl resin such as polyethylmethacrylate, urea resin, and Arabic rubber.

The dispersion medium 81 is a medium which disperses the white particles 82 and the black particles 83 in the microcapsule 80 (in other words, in the capsule 85). As the dispersion medium 81, water; an alcohol-based solvent, such as methanol, ethanol, isopropanol, butanol, octanol, methyl cellosolve; a variety of esters, such as ethyl acetate and butyl acetate; ketons, such as acetone, methylethylketone, and methylisobutyl ketone; aliphatic hydrocarbon, such as pentane, hexane, and octane; alicyclic hydrocarbon, such as cyclohexane and methylcyclohexane; aromatic hydrocarbon, such as benzene having a long-chain alkyl group, such as benzene, toluene, xylene, hexylbenzene, heptylbenzene, octylbenzene, nonylbenzene, decylbenzene, undecylbenzene, dodecylbenzene, tridecylbenzene, and tetradecylbenzene; halogenated hydrocarbon, such as methylene chloride, chloroform, carbon tetrachloride, and 1,2-dichloroethane; carboxylate; and other kinds of oils can be used in the form of a single material or a mixture. Further, surfactant may be added to the above-mentioned solvent to be used as the dispersion medium 81.

The white particles 82 are particles (polymer or colloid) composed of white pigments such as titanium dioxide, zinc oxide, and antimony trioxide and charged negative.

The black particles 83 are particles (polymer or colloid) composed of black pigments such as aniline black and carbon black and charged positive.

For this reason, the white particles 82 and the black particles 83 can move in the middle of the dispersion medium 81 owing to an electric field created by a potential difference between the pixel electrodes 21 and the common electrode 22.

According to circumstances, an electrolyte, a surfactant agent, a charge control agent which consists of particles, such as metal soap, resin, rubber, oil, varnish, and a compound, a dispersing agent, such as a titanium-based coupling agent, an aluminum-based coupling agent, and a silane-based coupling agent, a lubricant, and a stabilizer can be added to the pigments.

In FIGS. 4 and 5, in the case of applying a voltage between the pixel electrodes 21 and the common electrode 22 such that the potential of the common electrode 22 is relatively high, the black particles 83 charged positive are drawn to the pixel electrodes 21 in the microcapsules 80 by Coulomb force and white particles 82 charged negative are drawn to the common electrode 22 side in the microcapsules 80 by Coulomb force. As a result, as the white particles 82 gathers at the display surface side (i.e. the common electrode 22 side) in the microcapsule 80, the color of the white particles 82 (i.e. white color) can be displayed on the display surface of the display portion 3. Conversely, in the case of applying a voltage between the pixel electrode 21 and the common electrode 22 such that the potential of the pixel electrode 21 is relatively high, the white particles 82 charged negative are drawn to the pixel electrode 21 side by Coulomb force but the black particles 83 charged positive are drawn to the common electrode 22 side by Coulomb force. As a result, as the black particles 83 gather at the display surface side of the microcapsule 80, the color of the black particles 83 (i.e. black color) can be displayed on the display surface of the display portion 3.

Further, it is possible to display a gray color such as light gray, gray, and dark gray, which is a halftone between white and black by a distribution state of the white particles 82 and the black particles 83 between the pixel electrode 21 and the common electrode 22. Furthermore, it is possible to display red, green, and blue by replacing pigments used as the white particles 82 and the black particles 83 with pigments of red, green, and blue.

Next, a driving method of the electrophoretic display device according to this embodiment will be described with reference to FIGS. 6, 7, and 8.

FIG. 6 is a timing chart illustrating a driving method of the electrophoretic display device according to a first embodiment.

In FIG. 6, according to the driving method of the electrophoretic display device of the first embodiment, within an image writing-in period P1, either the first potential VH or the second potential VL is supplied to each of the first pixel electrodes 21a. As shown in the figure, the common electrode 22 is repeatedly supplied with a potential equal to the first potential and a potential equal to the second potential within a predetermined period T1. In other words, the first potential and the second potential are repeatedly supplied to the common electrode in predetermined periods T1. For this reason, the pixels 20 corresponding to the first pixel electrodes 21a supplied with the first potential are not applied with a voltage when the common potential Vcom becomes equal to the first potential, but applied with a voltage only when the common potential Vcom becomes equal to the second potential. That is, the first pixel electrodes 21a supplied with the first potential are periodically applied with a voltage which can display the black color. In a similar manner, the pixels 20 corresponding to the first pixel electrodes 21a supplied with the second potential are not applied with a voltage when the common potential Vcom becomes equal to the second potential, but applied with a voltage only when the common potential Vcom becomes equal to the first potential. That is, the first pixel electrodes 21a supplied with the second potential are periodically applied with the potential which can display the white color.

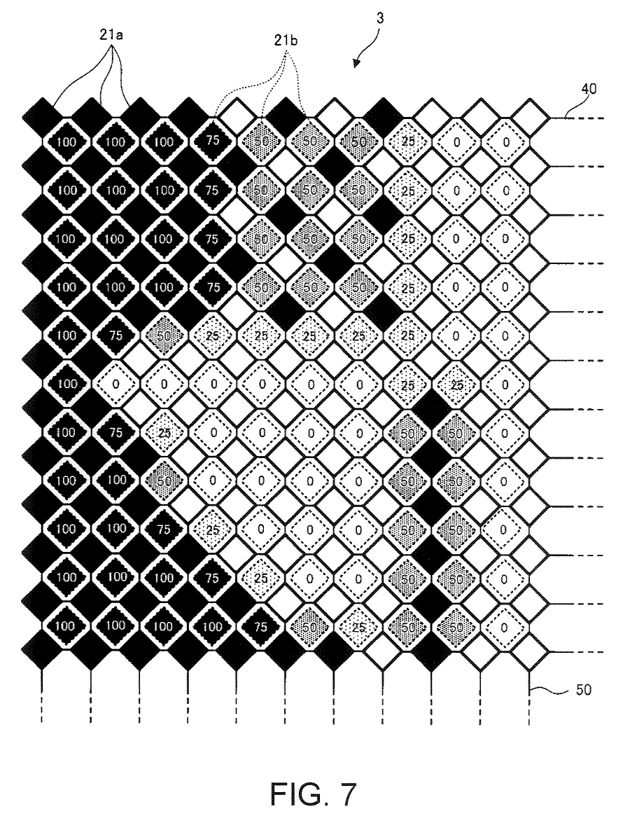

FIG. 7 is a plan view conceptually illustrating color tones of pixels of the electrophoretic display device according to the first embodiment.

In FIG. 7, for example during the image writing-in period, if the voltage for displaying the color tone (black or white) shown in the figure is applied to each of the first pixel electrodes 21a, the second pixel electrodes 21b are supplied with the potential of the first pixel electrodes 21a via the bonding layer 31 (see FIG. 4), and therefore, the voltage for showing the color tone shown in the figure is generated. Moreover, a value recorded in the second pixel electrode 21b of the figure is “0” when the color tone of the pixel 20 corresponding to the pixel electrode is white and “100” when the color tone is black.

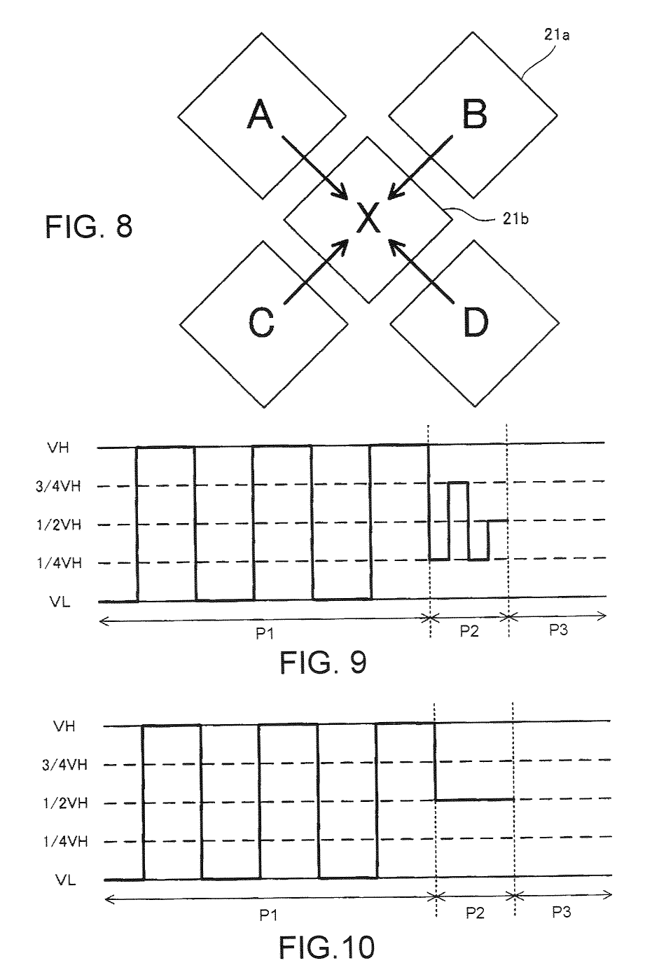

FIG. 8 is a conceptual view illustrating contribution of the surrounding first pixel electrodes to the second pixel electrode.

In FIG. 8, the values of the color tones of a single second pixel electrode X are obtained by the following equation (1) when a rate of potential contribution of each of the first pixel electrodes A, B, C, and D placed around the second pixel electrode X is 25%.

X=(A+B+C+D)/4 (1)

A, B, C, and D in the above equation are values (1 through 100) showing the color tones of the pixels 20 corresponding to the pixel electrodes.

For example, if a voltage for displaying the black is applied to all of four first pixel electrodes A, B, C, and D, X=100. So the pixels 20 corresponding to the second pixel electrodes X display the black like the pixels 20 corresponding to the surrounding first pixel electrodes 21a. If a voltage for displaying the black is applied to any three of the first pixel electrodes A, B, C, and D and a voltage for displaying the white is applied to the remaining first pixel electrode, X=75. So the pixels 20 corresponding to the second pixel electrodes X display gray close to black. If a voltage for displaying black is applied to any two of the first pixel electrodes A, B, C, and D and a voltage for displaying white is applied to the remaining two pixel electrodes, X=50. So, the pixels 20 corresponding to the second pixel electrodes X display gray which is almost the half-tone between black and white. If a voltage for displaying black is applied to any one of the first pixel electrodes A, B, C, and D and a voltage for displaying white is applied to the remaining three first pixel electrodes, X=25. So the pixels 20 corresponding to the second pixel electrodes X display gray almost close to white. If a voltage for displaying white is applied to all of the four first pixel electrodes A, B, C, and D, X=0. So the pixels 20 corresponding to the second pixel electrodes X display white like the pixels 20 corresponding to the surrounding first pixel electrodes 21a.

With reference to FIG. 6, during the image writing-in period P1, in the pixels 20b in which X=50, whenever the common potential Vcom changes in predetermined periods T1, the voltage applied to the pixels corresponding to the surrounding first pixel electrodes 21a changes. For this reason, whenever the common potential Vcom changes at predetermined periods T1, the electrophoretic particles 82 and 83 in the microcapsule 80 move to different sides, respectively of the second pixel electrode 21b and the common electrode 22. That is, the electrophoretic particles 82 and 83 move so as to show the different color tones in the case in which the common potential Vcom and the first potential are almost equal to each other within the predetermined period T1 and the case in which the common potential Vcom and the second potential are almost equal to each other within the predetermined period T1.

If a halftone creation period P2 shown in the figure is not provided and a next period of the image writing-in period P1 is an image maintaining period P3, and since the common potential Vcom is equal to either the first potential or the second potential, the electrodes fall to the high impedance state. In this case, the electrophoretic particles 82 and 83 in the microcapsule 80 move to either the pixel electrode 21 or the common electrode 22 and maintained close to either the pixel electrode 21 or the common electrode 22 for a relatively long time. Accordingly, the color tone displayed by the second pixels 20b in which X=50 does not become gray which is almost the halftone between white and black and is almost close to the color tone corresponding to the voltage applied to the electrodes right before the high impedance state. That is, there is possibility that the displayed color tone becomes the color tone different from the halftone.

However, in the driving method of the electrophoretic display device according to this embodiment, the common potential Vcom within the halftone creation period P2 repeatedly becomes a potential (i.e. VH) equal to the first potential and a potential (i.e. VL) equal to the second potential within a period T2 which is shorter than the predetermined period T1. Accordingly, a period during which the electrophoretic particles 82 and 83 in the microcapsule 80 move to the pixel electrode 21 and the common electrode 22, respectively becomes shorter. Accordingly, it is possible to prevent the proper halftone from not being able to be displayed in the second pixels 20b supposed to display the halftone attributable to the phenomenon that the electrophoretic particles 82 and 83 move too much.

Next, a modification of the driving method of the electrophoretic display device according to this embodiment will be described with reference to FIGS. 9 and 10.

FIG. 9 is a timing chart showing a first modification of the driving method of the electrophoretic display device according to the first embodiment.

In FIG. 9, the period of changing the common potential Vcom in the halftone creation period P2 is shorter and the potentials supplied as the common potential Vcom do not repeat of the first potential VH and the second potential VL, but repeat of a potential (¾VH) lower than the first potential and a potential (¼VH) higher than the second potential.

In this case, within the halftone creation period P2, force of making the electrophoretic particles 82 and 83 move toward the pixel electrode 21 and the common electrode 22 decreases. That is, as the voltage applied between the first pixel electrodes 21a and the common electrode 22 and between the second pixel electrodes 21 and the common electrode 22 is lowered, it is difficult for the electrophoretic particles 82 and 83 to move. Accordingly, in the second pixels 20b supposed to display the halftone, it is possible to effectively prevent the proper halftone from not being able to be displayed attributable to the phenomenon that the electrophoretic particles 82 and 83 move too much.

In the halftone creation period P2, the period of change of the common potential Vcom may not be constant. For example, if the period is set to be gradually shorter, it is possible to more properly display the halftone. Furthermore, in the halftone creation period P2, the voltage value of the common potential Vcom may not be constant. For example, the voltage between the pixel electrode 21 and the common electrode 22 is set to be gradually lower, it is possible to more properly display the halftone.

FIG. 10 is a timing chart showing a second modification of the driving method of the electrophoretic display device according to the first embodiment.

In FIG. 10, during the halftone creation period P2, the common potential Vcom may be the half potential (½ VH) between the first potential and the second potential. In this case, as described with reference to FIGS. 6 and 9, it is possible to prevent the proper halftone from not being able to be displayed in the pixels 20 supposed to display the halftone, attributable to the phenomenon that the electrophoretic particles 82 and 83 move too much. Moreover, since the common potential Vcom is constant and it is unnecessary to change the period, it is possible to prevent complicated processing.

As described above, according to the electrophoretic display device of the first embodiment, it is possible to display the halftone by the second pixels 20b corresponding to the second pixel electrodes 21b, it is possible to perform antialiasing by making the contour of the displayed image become the halftone, and therefore, it is possible to display an image with a smooth contour.

Further, since the second pixel electrodes 21b are placed between adjacent rows or columns of the first pixel electrodes 21a, the average distance (interval) between adjacent first pixel electrodes 21a increases. With such a structure, it is possible to reduce influence of the potential difference between the pixel electrodes. As a result, it is possible to reduce current leakage compared with the conventional electrophoretic display device with no second pixel electrodes. Accordingly, it is possible to suppress the increase of the power consumption.

### Second Embodiment

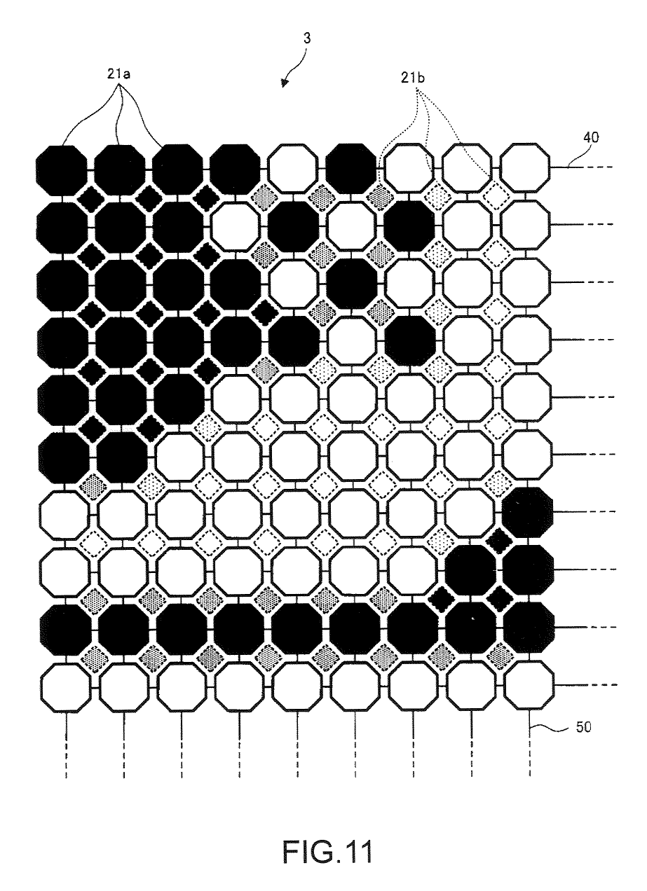

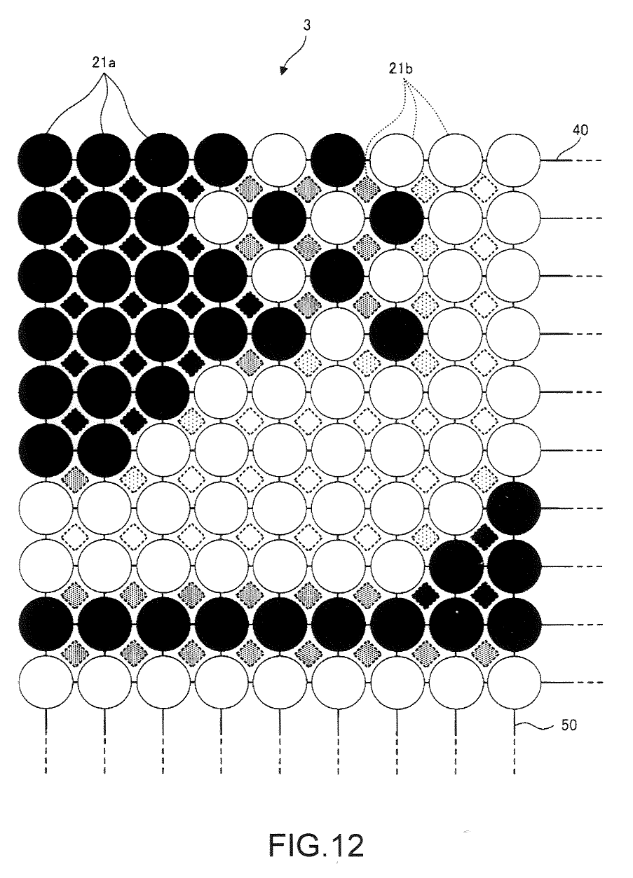

Next, an electrophoretic display device according to a second embodiment of the invention will be described with reference to FIGS. 11 and 12. The second embodiment is different from the first embodiment from an aspect of the structure of the first pixel electrodes 21a and the second pixel electrodes 21b. However, the second embodiment and the first embodiment are the same in the structure of other elements and the operation. Accordingly, as for the second embodiment, only parts different from the first embodiment will be described, and description of the other parts will be omitted.

FIG. 11 is a plan view conceptually showing color tones of pixels of the electrophoretic display device according to the second embodiment.

In FIG. 11, in the electrophoretic display device according to the second embodiment, the first pixel electrodes 21a have an octagonal shape. In this case, the shape of the first pixel electrodes 21a is more rounded as compared with the shape of the first pixel electrodes 21a shown in FIG. 7. Accordingly, it is possible to smooth the contour of the image display by the first pixels 20a of the display portion 3. That is, it is possible to improve the quality of image.

FIG. 12 is a plan view illustrating a modification of the electrophoretic display device according to the second embodiment.

In FIG. 12, the first pixel electrodes 21a have a circular shape. In this case, the first pixel electrodes 21a have the shape with no sharp corners. Accordingly, it is possible to further smooth the contour of the image displayed by the first pixels 20a of the display portion 3.

With reference to FIG. 11, the second pixel electrodes 21b have a quadrangular shape. With this structure, it is possible to appropriately place the second pixel electrodes 21b at regions surrounded by the first pixel electrodes 21a having the octagonal shape. That is, it is possible to place the second pixel electrodes 21b so that each of the second pixel electrodes 21b is uniformly and steadily influenced by the first pixel electrodes 21a.

In the second embodiment, the size (area) of each of the second pixel electrodes 21b is smaller than that of each of the first pixel electrodes 21a. With this structure, it is possible to reduce the ratio of the second pixels 20b for displaying the halftone with respect to the first pixels 20a for displaying white or black in the display portion 3. As a result, it is possible to improve contrast of the image displayed in the display portion 3.

As described above, according to the electrophoretic display device according to the second embodiment, since it is possible to appropriately display the halftone by the second pixels 20b corresponding to the second pixel electrodes 21b, it is possible to display the image of high quality.

### Third Embodiment

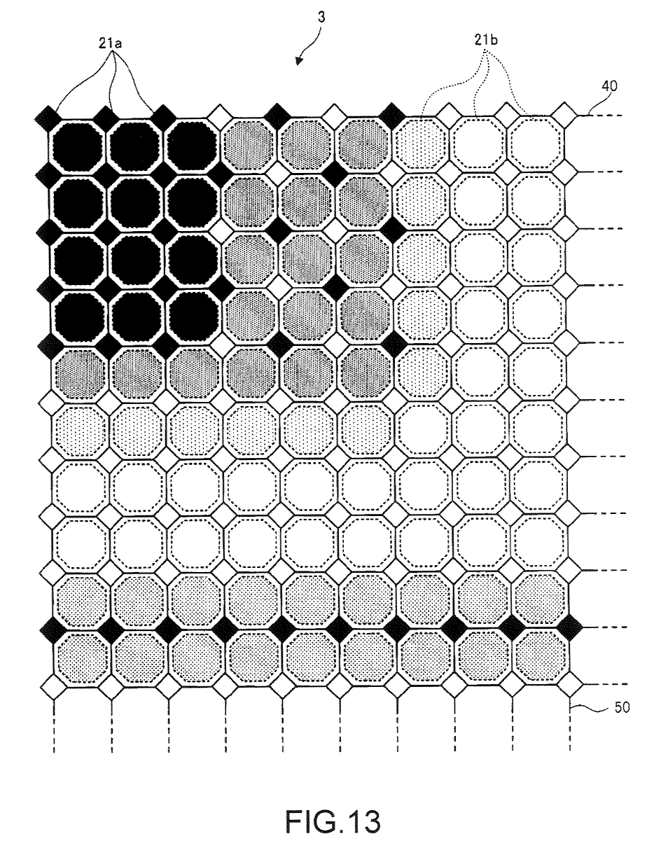

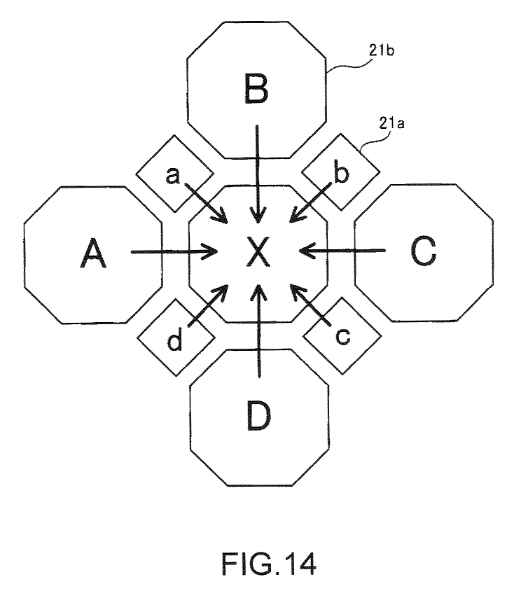

Next, an electrophoretic display device according to a third embodiment will be described with reference to FIGS. 13 and 14. The third embodiment is different from the first and second embodiments from the point of view of the structure of the first pixel electrode 21a and the second pixel electrode 21b, but the same as the first and second embodiments from the point of view of the structure of other part and operation. As for the third embodiment, only part different from the first and second embodiments will be described in detail below, but description of the same elements will be omitted.

FIG. 13 is a plan view conceptually illustrating color tones of pixels of the electrophoretic display device according to the third embodiment.

In FIG. 13, in the electrophoretic display device according to the third embodiment, the first pixel electrodes 21a have the quadrangular shape and the second pixel electrodes 21b have the octagonal shape. Accordingly, like to electrophoretic display device according to the above-described second embodiment, it is possible to properly place the first pixel electrodes 21a and the second pixel electrodes 21b.

FIG. 14 is a conceptual view illustrating contribution of potential of the surrounding first and second pixel electrodes to the second pixel electrode.

In FIG. 14, in the electrophoretic display device according to the third embodiment, as the distance between adjacent second pixel electrodes 21b is relatively short, the second pixel electrode 21b is influenced by the potential of the surrounding second pixel electrodes 21b besides the potential of the surrounding first pixel electrodes 21a. In greater detail, if a rate of the potential contribution of the second pixel electrodes A, B, C, and D placed around the second pixel electrode X is 15%, and a rate of the potential contribution of the first pixel electrodes a, b, c, and d is 10%, the color tone of the second pixel electrode X is obtained by the following equation (2).

X=(a+b+c+d)/40+(A+B+C+D)/60 (2)

In the above equation, a, b, c, d, A, B, C, and D are values (1 to 100) showing the color tones of the pixels 20 corresponding to the pixel electrodes 21.

As a result, the electrophoretic display device according to the third embodiment can display more various levels of halftones as compared with the electrophoretic display devices according to the first and second embodiments. Accordingly, it is possible to display the image of high quality.

With reference to FIG. 13, with the third embodiment, the size of each of the second pixel electrodes 21b is larger than that of each of the first pixel electrodes 21a. With such a structure, a ratio of area of the second pixels 20b for displaying the halftone to area of the display portion 3 is higher than a ratio of area of the first pixels 20a for displaying black or white to area of the display portion 3. Accordingly, it is possible to further smooth the contour of the image displayed in the display portion 3.

As described above, according to the electrophoretic display device of the third embodiment, in the pixels 20 corresponding to the second pixel electrodes 21b, it is possible to appropriately display the halftone. As a result, it is possible to display the image of higher quality.

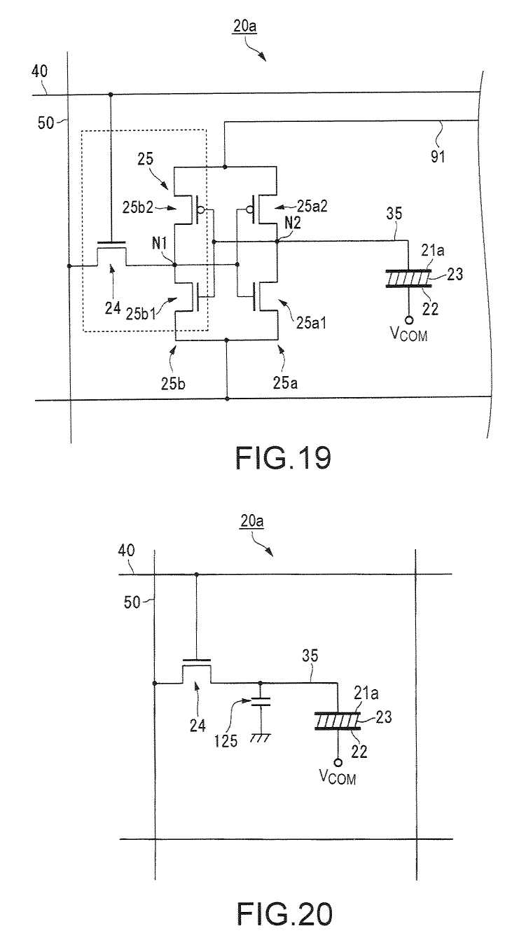

Each of the first pixels 20a according to each of the embodiments includes a memory circuit 25 and a switch circuit 110. However, alternatively each of the first pixels 20a may not include the switch circuit 110. In such a case, the output terminal N2 of the memory circuit 25 is directly connected to the first pixel electrode 21a. With such a structure, the first pixel 20a can be formed using five transistors. The first pixel 20a may be one-transistor and one-capacitor (1T1C) type including a pixel switching transistor 24 and a capacitor which maintains the image signal supplied to the pixel switching transistor 24. According to this structure, it is possible to reduce the number of transistors included in each first pixel 20a. Such kind of pixel circuit will be described with reference to FIGS. 19 and 20.

Each of the transistors of the above embodiments may be an organic thin film transistor 24. With such a structure, it is possible to form the first pixels 20a on a flexible substrate, such as a plastic substrate.

### Fourth Embodiment

Next, an electrophoretic display device according to a fourth embodiment will be described.

The fourth embodiment is different from the first embodiment from the point of view of the structure of the first pixel electrodes 21a and the second pixel electrodes 21b, but is the same as the first embodiment from the point of view of the other part and operation. As for the fourth embodiment, only part different from the first embodiment will be described in detail, but description about the same constituent elements as the first embodiment will be omitted. Like elements between the first embodiment and the fourth embodiment are referenced with like numbers.

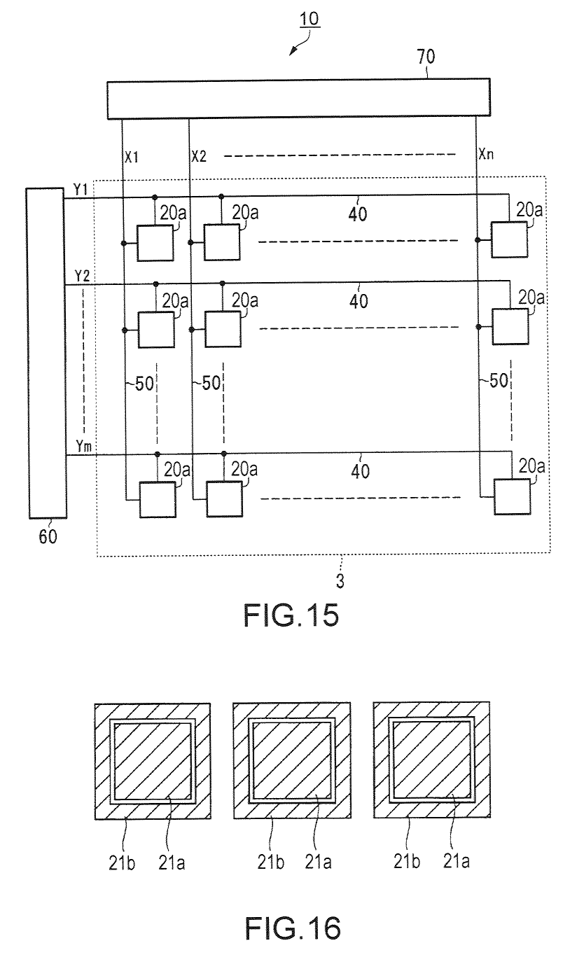

FIG. 15 is a block diagram illustrating a schematic structure of the electrophoretic display device according to this embodiment and corresponds to FIG. 1.

The electrophoretic display device 10 is an active matrix electrophoretic display device and includes a display portion 3 in which a plurality of first pixels 20a is arranged, a scan line drive circuit 60, and a data line drive circuit 70.

The display portion 3 is provided with a plurality of scan lines 40 (Y1, Y2 , . . . , and Ym) extending from the scan line drive circuit 60 and a plurality of data lines 50 (X1, X2, . . . . , and Xn) extending from the data line drive circuit 70. The first pixels 20a are placed corresponding to intersections of the scan lines 40 and the data lines 50. Each of the first pixels 20a is connected to the scan line 40 and the data line 50. The electrophoretic display device 10 is further provided with a plurality of second pixels besides the first pixels 20a, but illustration of the second pixels is omitted in FIG. 15.

Although illustration is omitted, a power supply circuit and a controller are placed around the display portion 3 besides the scan line drive circuit 60 and the data line drive circuit 70. In greater detail, the electrophoretic display device is provided with the same constituent elements as shown in FIG. 1.

Each of the first pixels 20a is connected to a power supply circuit, a high potential power source line, low potential power source line, a first control line, and a second control line like the structure of FIG. 1 besides the scan line 40 and the data line 50. The power supply circuit generates various kinds of signals to be supplied to the above wirings under the control of the controller like the description of the first embodiment, and performs electrical connection and disconnection (causing a high impedance state) of the wirings.

The first pixels 20a having a rectangular shape are placed in a manner such that sides of each first pixel are substantially parallel with the scan lines 40 and the data lines 50. This is different from the pixel arrangement of FIG. 1 in which the sides of each first pixel are oblique to the scan lines and the data lines at an angle of 45°.

Each of the first pixels 20a is provided with the same pixel circuit shown in FIG. 2. In more detail, as shown in FIG. 2, the pixel circuit includes a pixel switching transistor 24, a latch circuit (memory circuit) 25, transmission gates 111 and 112 which are potential control switch circuits, and a first pixel electrode 21a.

FIG. 16 is a plan view illustrating arrangement of the first pixel electrodes and the second pixel electrodes and corresponds to FIG. 3.

FIG. 16 shows a plurality of pixels, for example, three pixels 20. In more detail, appearance of first pixel electrodes 21a and second pixel electrodes 21b in a plan view of an element substrate is shown. As shown in FIG. 16, second pixel electrodes 21b which are floating electrodes corresponding to first pixel electrodes 21a are provided.

The second pixel electrodes 21b are not connected to the first pixel electrodes 21a, other wirings, and other electrodes, so that they are electrically floating electrodes. The second pixel electrodes 21b are provided in a region to surround the first pixel electrodes 21a in a plan view. In greater detail, the second pixel electrodes 21b are provided at a ring-shaped region formed along the contour of the first pixel electrode 21a having a substantially rectangular shape in a plan view. Gap is provided between the second pixel electrodes 21b and the first pixel electrodes 21a so that the second pixel electrodes 21b and the first pixel electrodes 21a do not contact with each other.

That is, regions overlapping the first pixel electrodes 21a become the first pixels, and regions overlapping the second pixel electrodes 21b become the second pixels. In other words, the second pixels are formed to surround the first pixels. With this embodiment, the second pixel electrodes 21b are provided for the first pixel electrodes 21a of all of the first pixels 20a. Accordingly, part of two second pixel electrodes 21b is placed between adjacent two first pixel electrodes 21a. In FIG. 16, only three first pixel electrodes 21a adjacent to one another in a lateral direction of the figure are shown, but such a structure may be applied to the longitudinal and lateral arrangement of the first pixel electrodes 21a. Accordingly, part of the second pixel electrodes 21b is placed between adjacent rows or columns of the first pixel electrodes 21a. From another point of view, the second pixel electrode 21b is placed at a region between adjacent first pixel electrodes 21a in a row direction or a region between adjacent first pixel electrodes 21a in a column direction.

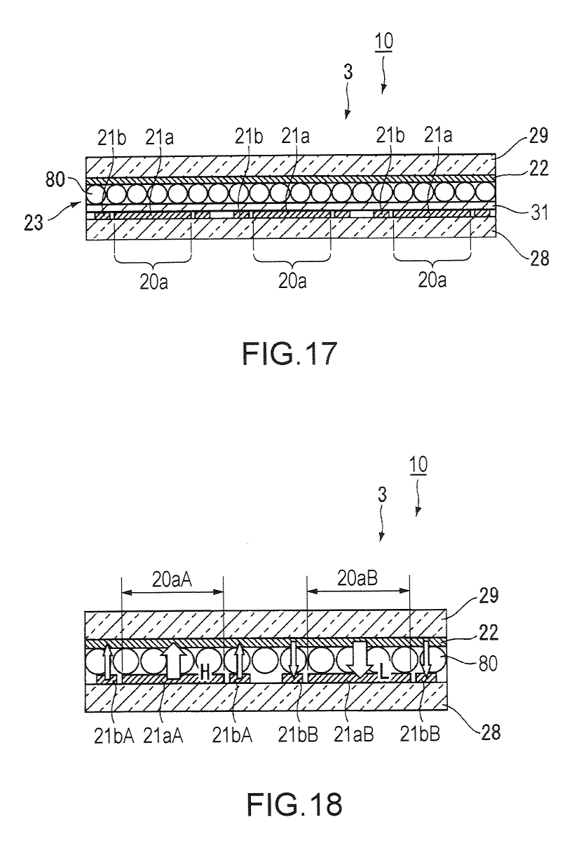

FIG. 17 is a partial sectional view illustrating the display portion of the electrophoretic display device and corresponds to FIG. 4. The electrophoretic display device 10 has a structure in which electrophoretic elements 23 formed by arranging a plurality of microcapsules 80 are interposed between an element substrate 28 and an opposing substrate 29 like the structure of FIG. 4. In the display portion 3, a plurality of first pixel electrodes 21a and a plurality of second pixel electrodes 21b are arranged and formed on the electrophoretic element 23 side of the element substrate 28. The electrophoretic elements 23 are bonded to the pixel electrodes via the bonding layer 31.

FIG. 18 is a sectional view illustrating operation when applying a voltage to adjacent first pixel electrodes. FIG. 18 shows adjacent two first pixel electrodes 21aA and 21aB as an example of the first pixel electrodes.

As shown in FIG. 18, in the case in which the first pixel electrode 21aA shown on the left side of the figure is applied with a voltage H of high level, and the first pixel electrode 21aB shown in the right side of the figure is applied with a voltage L of low level, the potential difference exists between the pixel electrodes. On the other hand, two second pixel electrodes 21bA and 21bB are placed between the first pixel electrode 21aA and the first pixel electrode 21aB, and therefore, the distance (gap) between two first pixel electrodes is surely set. For this reason, it becomes difficult for the leaking current to flow between the first pixel electrodes 21aA and 21aB.

The potential of the second pixel electrode 21bA is induced by the first pixel electrode 21aA to which the voltage H of high level is applied and becomes close to the voltage H of high level. Accordingly, in the case in which the voltage COM of the common electrode 22 is low level, an electric field is created between the first pixel electrode 21aA and the common electrode 22 and an electric field is created between the second pixel electrode 21bA and the common electrode 22. Owing to the electric field, electrophoretic particles move in the electrophoretic elements within a region overlapping the second pixel electrode 21bA in a plan view as well as in the electrophoretic elements within a region overlapping the first pixel electrode 21aA in a plan view. In this manner, the display can be performed at the region at which the second pixel electrodes 21bA are provided besides at the region at which the first pixel electrodes 21aA are provided.

The potential of the second pixel electrodes 21bB is induced by the first pixel electrode 21aB to which the voltage L of low level is applied, and becomes close to the voltage L of low level. Accordingly, in the case in which the voltage COM of the common electrode 22 becomes high level, an electric field is created between the first pixel electrode 21aB and the common electrode 22 and an electric field is created between the second pixel electrode 21bB and the common electrode 22. Owing to the electric field, electrophoretic particles more in the electrophoretic elements within a region overlapping the second pixel electrode 21bB in a plan view as well as in the electrophoretic elements within a region overlapping the first pixel electrode 21aB in a plan view. In this manner, it is possible to perform the display by part of the pixels 20 at the region at which the second pixel electrodes 21bB are provided besides the region at which the first pixel electrodes 21aB are provided.

That is, as in the description of the first embodiment, it is possible to perform the display not only by the first pixels but also the second pixels placed around the first pixels.

In this manner, according to this embodiment, as the second pixel electrodes 21b corresponding to the first pixel electrodes are provided between the adjacent first pixel electrodes 21a, it is possible to increase the distance (gap) between the adjacent first pixel electrodes 21a. As the distance between the adjacent first pixel electrodes 21a increases, it is possible to reduce influence of the potential difference created between the pixel electrodes and suppress the current leakage. Therefore, it is possible to suppress the increase in the power consumption.

Since the potential of the second pixel electrodes 21b is induced by the potential of the first pixel electrodes 21a, and the second pixel electrodes 21b have their own potentials, the display is performed even in the region at which the second pixel electrodes 21b are provided. In this manner, as in the description about the above embodiments, it is possible to display by the second pixel electrodes 21b existing in the space between the first pixel electrodes 21a.

Like this embodiment, in the case in which the second pixel electrodes 21b are provided at regions which surround the first pixel electrodes 21a in a plan view, it is possible to ensure the distance around each of the first pixel electrodes 21a in all directions in a plan view. With this structure, it is possible to surely suppress the current leakage. As the display by the second pixel electrodes 21b is performed at regions which surround the first pixel electrodes 21a, it is possible to perform the display of high contrast.

Even in the case of the structure in which the memory circuits 25 (latch circuits) are provided like this embodiment (FIG. 2), it is possible to suppress the current leakage, and therefore, it is possible to suppress increase in the power consumption. In particular, in the case of the structure in which the latch circuits 25 are provided, since there is a tendency in which large potential difference is easily created between the adjacent first pixel electrodes 21a, the advantage is very effective.

The technical scope of this embodiment is not limited to the above description, and the embodiment can be properly altered and changed within the scope which does not depart from the spirit of the invention.

In the above description, the embodiment has the structure in which the second pixel electrodes 21b are provided for all of the first pixel electrodes 21a, but it not limited to such structure. For example, the second pixel electrodes 21b may be provided for only some of the first pixel electrodes 21a.

FIG. 19 and FIG. 20 are views showing pixel circuits of different aspects.

The pixel circuit is not limited to the circuit structure of FIG. 2, but may have a different circuit structure.

For example, as shown in FIG. 19, the pixel circuit may have a structure in which a switch circuit composed of two transmission gates is not provided at a back stage of the memory circuit 25. In such a case, the output terminal N2 of the memory circuit 25 is directly connected to the first pixel electrode 21a. Other part of the pixel circuit is the same as the circuit structure of FIG. 2.

As shown in FIG. 20, the pixel circuit may have a structure provided with a capacitor element 125 instead of the memory circuit 25. In FIG. 20, one terminal of the capacitor element 125 is connected between the pixel switching transistor 24 and the first pixel electrode 21a and the remaining terminal of the capacitor element is grounded. In other words, one terminal of the capacitor element 125 is connected to a wiring 35 which connects a drain terminal of the pixel switching transistor 24 to the first pixel electrode 21a. That is, the pixel circuit of FIG. 20 is a 1T1C-type pixel circuit composed of one transistor and one capacitor element.

In this circuit structure, like the circuit structure of FIG. 2, it is possible to suppress the current leakage and to suppress the increase in the power consumption.

### Electronic Apparatus

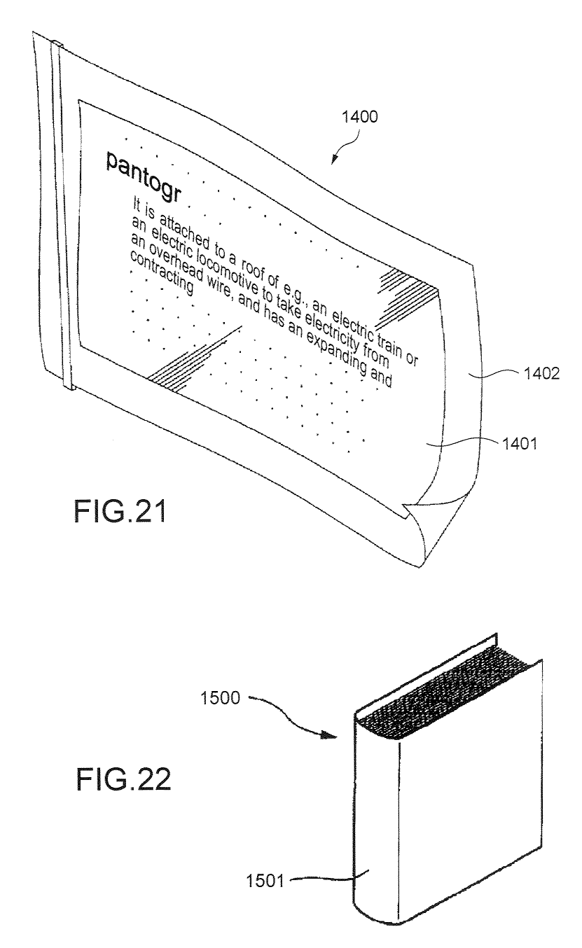

Next, electronic apparatuses to which the above-mentioned electrophoretic display device 1 is applied will be described with reference to FIGS. 21 and 22. In the following description, the cases in which the electrophoretic display device is applied to electronic paper and an electronic note are exemplified.

FIG. 21 is a perspective view illustrating the structure of the electronic paper.

As shown in FIG. 21, the electronic paper 1400 has the electrophoretic display device 1 according to the above-described embodiment as a display portion 1401. The electronic paper 1400 has a structure including a main body 1402 composed of rewritable sheets, each having flexibility and typical paper-like texture and bendability.

FIG. 22 is a perspective view illustrating the structure of the electronic note.

As shown in FIG. 22, the electronic note 1500 has a structure in which a plurality of sheets of the electronic paper 1400 shown in FIG. 21 is bound and the stack of the electronic paper 1400 is interposed between covers 1501. The covers 1501 have a display data input unit (not shown) for allowing display data sent from an external device to be input. With this structure, in the state in which sheets of the electronic paper are bound, it is possible to change and update the display contents according to the display data.

As each of the electronic paper 1400 and the electronic note 1500 includes the electrophoretic display device 1 according to the above-mentioned embodiment, it is possible to display the image of high quality.

Besides the above, the electrophoretic display device 1 according to the above embodiments can be applied to a display portion of an electronic apparatus, such as a wrist watch, a cellular phone, and a portable audio machine.

The invention is not limited to the above embodiments, but can be properly modified, changed or altered within the scope which does not contradict the gist or sprit of the invention read from the scope of the claims and the entire specification. The electrophoretic display device 1 which undergoes such change, modification, and alteration, the electronic apparatus including such electrophoretic display device 1, and the driving method of the electrophoretic display device 1 may fall into the technical scope of the invention.

What is claimed is:

1. An electrophoretic display device comprising:
a first substrate and a second substrate;
an electrophoretic element which is placed between the first and second substrates and contains electrophoretic particles;
a plurality of first pixel electrodes formed on an electrophoretic element side of the first substrate;
second pixel electrodes provided on the electrophoretic element side of the first substrate in an electrically floating state; and
a common electrode provided on an electrophoretic display side of the second substrate so as to face the first and second pixel electrodes,
wherein a region where the second pixel electrodes are placed includes part of a space between the adjacent first pixel electrodes.

2. The electrophoretic display device according to claim 1, wherein the second pixel electrodes are provided so as to surround the first pixel electrodes in a plan view.

3. The electrophoretic display device according to claim 1, further comprising:
a plurality of scan lines and a plurality of data lines provided on the first substrate so as to intersect with each other; and
a pixel circuit connected to the first pixel electrode for supplying a pixel potential according to an image signal supplied via the data line to the first pixel electrode,
wherein the first pixel electrodes are placed on the first substrate so as to form a matrix corresponding to intersections of the plurality of scan lines and the plurality of data lines, and
wherein the second pixel electrodes are placed at the region including any one of a spaces between the first pixel electrodes adjacent to each other in a row direction of the matrix, a space between the first pixel electrodes adjacent to each other in a column direction of the matrix, or a space between the first pixel electrodes adjacent to each other in an oblique direction with respect to the row direction and the column direction.

4. The electrophoretic display device according to claim 3, wherein the second pixel electrode is placed at a region surround by adjacent four first pixel electrodes arranged in two rows and in two columns.

5. The electrophoretic display device according to claim 4, wherein the first and second pixel electrodes have substantially the same size from a point of a plan view of the first substrate.

6. The electrophoretic display device according to claim 4, wherein each of the second pixel electrodes is larger than each of the first pixel electrodes from a point of a plan view of the first substrate.

7. The electrophoretic display device according to claim 4, wherein each of the second pixel electrodes is smaller than each of the first pixel electrodes from a point of a plan view of the first substrate.

8. The electrophoretic display device according to claim 4, wherein each of the first and second pixel electrodes has a quadrangular shape whose sides are oblique to a direction in which the data lines extend from a point of a plan view of the first substrate.

9. The electrophoretic display device according to claim 4, wherein at least one of the first pixel electrodes and the second pixel electrodes has a circular shape from a point of a plan view of the first substrate.

10. An electronic apparatus comprising the electrophoretic display device according to claim 1.

11. A driving method of an electrophoretic display device structured such that an electrophoretic element containing electrophoretic particles is disposed between a first substrate and a second substrate,
wherein the electrophoretic display device includes:
a plurality of scan lines and a plurality of data lines provided on the first substrate so as to intersect with each other;
first pixel electrodes placed on an electrophoretic element side of the first substrate so as to form a matrix corresponding to intersections of the plurality of scan lines and the plurality of data lines;
a pixel circuit connected to the first pixel electrode for supplying a pixel potential according to an image signal supplied via the data line to the first pixel electrode;
a second pixel electrode provided in an electrically floating state at a region including any one of a space between the first pixel electrodes adjacent to each other in a row direction of the matrix of a portion of the electrophoretic element side on the first substrate, a space between the first pixel electrodes adjacent to each other in a column direction of the matrix, or a space between the first pixel electrodes adjacent to each other in an oblique direction with the row direction and the column direction; and
a common electrode provided on an electrophoretic element side of the second substrate so as to face the first pixel electrodes and the second pixel electrode,
wherein the driving method includes:
an image writing-in step of supplying either a first potential or a second potential lower than the first potential as a pixel potential to each of the plurality of the first pixel electrodes and repeatedly supplying a potential equal to the first potential and a potential equal to the second potential to the common electrode as a common potential in predetermined periods during an image writing-in period;
a halftone creating step of displaying a halftone in a second pixel by supplying either the first potential or the second potential to each of the plurality of first pixel electrodes as the pixel potential and repeatedly supplying a potential equal to the first potential and a potential equal to the second potential to the common electrode as the common potential in periods shorter than the predetermined periods during a halftone creating period continuing from the image writing-in period; and
an image maintaining step of causing the first pixel electrodes and the common electrode to fall into a high impedance state in which the first pixel electrodes and the common electrode are electrically disconnected during an image maintaining period continuing from the halftone creating period.

12. A driving method of an electrophoretic display device structured such that an electrophoretic element containing electrophoretic particles is interposed between a first substrate and a second substrate,
wherein the electrophoretic display device includes:
a plurality of scan lines and a plurality of data lines provided on the first substrate so as to intersect each other;
first pixel electrodes placed on an electrophoretic element side of the first substrate so as to form a matrix corresponding to intersections of the plurality of scan lines and the plurality of data lines;
a pixel circuit connected to the first pixel electrode for supplying a pixel potential according to an image signal supplied via the data line to the first pixel electrode;
a second pixel electrode provided in an electrically floating state at a region including any one of a space between the first pixel electrodes adjacent to each other in a row direction of the matrix, a space between the first pixel electrodes adjacent to each other in a column direction of the matrix, or a space between the first pixel electrodes adjacent to each other in an oblique direction with respect to the row direction and the column direction, at a portion on the electrophoretic element side on the first substrate; and
a common electrode provided on an electrophoretic element side of the second substrate so as to face the first and second pixel electrodes,
wherein the driving method includes:
an image writing-in step of supplying either a first potential or a second potential lower than the first potential to each of the plurality of the first pixel electrodes as a pixel potential and repeatedly supplying a potential equal to the first potential and a potential equal to the second potential to the common electrode as a common potential in predetermined periods during an image writing-in period;
a halftone creating step of displaying a halftone in a second pixel by supplying either the first potential or the second potential to each of the plurality of first pixel electrodes as the pixel potential and repeatedly supplying a third potential lower than the first potential and a fourth potential higher than the second potential and lower than the third potential to the common electrode as the common potential in periods shorter than the predetermined periods during a halftone creating period continuing from the image writing-in period; and
an image maintaining step of causing the first pixel electrodes and the common electrode to fall to a high impedance state in which the first pixel electrodes and the common electrode are electrically disconnected during an image maintaining period continuing from the halftone creating period.
